(19) United States
(12) Patent Application Publication
(10) Pub. No.: US 2023/0138840 A1
(43) Pub. Date: May 4, 2023

(54) Pipette Tip

(71) Applicant: Eppendorf SE, Hamburg (DE)

(72) Inventors: Hanna Rethwisch, Hamburg (DE); Maren Leonhardt, Hamburg (DE); Laura Koch, Hamburg (DE)

(73) Assignee: Eppendorf SE, Hamburg (DE)

(21) Appl. No.: 17/912,958

(22) PCT Filed: Mar. 26, 2021
(86) PCT No.: PCT/EP2021/057967

§ 371 Date: Sep. 20, 2022

(30) Foreign Application Priority Data
Apr. 3, 2020 (EP) 20167992.5

(51) Int. Cl. B01L 3/02

(52) U.S. Cl. CPC B01L 3/0275; B01L 2200/0689; B01L 2300/123; B01L 2200/025; B01L 2300/0832

(57) ABSTRACT

A pipette tip made of plastic with an elongated tubular body with a lower opening at the lower end for the passage of liquid and an upper opening at the upper end for clamping onto an attachment of a pipetting device, wherein a seating region for the attachment is present next to the upper opening on the inner circumference of the tubular body, wherein at least one flattened area extending in the axial direction is present next to the upper opening on the outer circumference of the tubular body, the wall thickness of the tubular body gradually decreases in a cross-section through the tubular body, starting from one of the two regions of the tubular body adjoining the flattened area, in the flattened area towards its central region, and the flattened area has in the cross-section through the tubular body a straight or a less strongly curved profile than the adjoining regions.

### BACKGROUND OF THE INVENTION

The invention relates to a pipette tip.

Pipette tips are used along with pipettes and other metering devices in particular in medical, biological, biochemical, and chemical laboratories for metering liquids. In the following, pipettes and other metering devices are referred to collectively as “pipetting devices.” Pipette tips have an elongated tubular body, which has a lower opening on the lower end for the passage of liquid and an upper opening on the upper end for clamping onto the attachment of a pipetting device. Pipette tips usually have a generally conical shape, the cross-section of which enlarges from the lower opening toward the upper opening. Standardized conical or respectively truncated conical attachments (working cone) are known with a standard geometry that is used uniformly by many manufacturers and is characterized by a specific average diameter and by a specific cone angle of the conical attachment for each pipette tip size.

Multichannel pipetting devices serve to simultaneously take up liquid from one or more vessels or respectively discharge liquid into one or more vessels. They are often used for processing microtiter plates, which have a plurality of vessels in a matrix-like arrangement. For this purpose, multichannel pipetting devices have multiple conical attachments arranged parallel next to each other in one or more parallel rows on which pipette tips can be clamped. In adaptation to a frequently used format of microtiter plates with 96 (8×12) or 384 (16×24) vessels (wells) according to the ANSI standard, multichannel pipettes with 8, 12, 16, or 24 attachments in a row are known. Multichannel metering devices with a metering head having 96 or 384 attachments are also known. Corresponding to the distance of adjacent vessels of microtiter plates with 96 or 384 vessels, adjacent attachments have a distance of 9 mm or 4.5 mm from each other.

When embodied as an air cushion pipetting device, the pipetting device has at least one displacement apparatus for air, which is connected in a communicating manner to a through-hole of at least one attachment. By means of the displacement apparatus, an air cushion can be displaced to aspirate liquid into a pipette tip clamped onto the attachment and expel it therefrom. The displacement apparatus is usually embodied as a cylinder with a plunger movable therein. However, displacement apparatuses with a displacement chamber and at least one deformable wall are also known, wherein a deformation of the wall displaces the air cushion.

In the embodiment as a direct displacement pipetting device, a small plunger is arranged in the pipette tip and is coupled with a coupling element of a plunger drive of the pipetting device when the pipette tip is mounted on an attachment, which coupling element can be displaced in a through-hole of the attachment.

The liquid is preferably taken up into the pipette tip in a single step or in multiple small steps. The liquid is discharged when pipetting in a single step and when dispensing in multiple small steps.

Pipetting devices usually have an ejector that acts on the upper edge of the pipette tip to press it off the attachment. In multichannel pipetting devices, the ejector can be simultaneously pressed against the upper edges of multiple pipette tips. By means of the ejector, the user can separate the pipette tips that are contaminated with liquid from the attachment without touching them.

The pipetting device can be a manual pipette that the user can hold and actuate with only one hand. It can also be a metering station (“pipetting station”) or a metering machine (“pipetting machine”), in which a metering head with one or more attachments can be displaced above a work surface on a robot arm or on another transmission system. The pipetting device can also be a component of a laboratory machine (“workstation”) that, in addition to metering, can perform other treatments of liquids (e.g., mixing, tempering, analyzing).

To avoid erroneous metering, the pipette tip must be clamped onto the attachment sufficiently firmly or respectively in a sufficiently sealing manner. In addition, the forces for mounting and ejecting the pipette tip from the attachment must not be too high. Conventional pipette tips are thick-walled and rigid in the contact region with the conical attachment. During mounting, the pipette tips are elastically widened at the circumference by the attachment. The spring characteristic is steep, such that high mounting forces must be applied. After mounting, a correspondingly high static friction acts between the attachment and the pipette tip, which must be overcome during ejection. The user is strained by the high forces for mounting and ejecting the pipette tip. This can trigger illnesses which are summarized with the term “cumulative trauma disorders” (CTD). If the mounting and ejecting take place by means of motorized drives, they must be correspondingly powerful and have a high power consumption.

U.S. Pat. No. 6,197,259 describes a pipette tip that can be mounted firmly to an attachment of a pipette by applying relatively low axial mounting forces of six pounds (26.7 N) and can be ejected from it by applying relatively low ejection forces of three pounds (13.3 N). The pipette tip has a conical upper end with an inner diameter at the upper end which is greater than the diameter of the attachment of the pipette on which the pipette tip is to be mounted. Furthermore, the pipette tip has a hollow middle portion and an annular sealing region at the connection between the upper end and the middle portion. At and next to the sealing region, the middle portion has a side wall with a wall thickness between 0.2 and 0.5 mm. The annular sealing region has an inner diameter that is small than a value “x,” and is designed so that it engages with the lower end of a sealing zone of the attachment in order to be widened radially when the attachment is inserted. This generates a liquid-tight seal between the sealing zone of the attachment and the sealing region of the pipette tip. Furthermore, the pipette tip, on the inner side next to the sealing region, has lateral stabilizing means, which engage with the outer surface of the attachment to stabilize the pipette tip on the attachment. The lateral stabilizing means have at least three contacts spaced apart from each other in the circumferential direction, which extend inwardly from the inner surface of the pipette tip. The diametral distance of the contacts is dimensioned such that they engage easily with the lower end of the attachment and enable the lower end to slide past without widening the side walls of the pipette tip on which the contacts are arranged. When the lower end of the sealing zone of the attachment engages with the sealing region of the pipette tip, the pipette tip is stretched in the sealing region and immediately next to it. When the contacts guide the pipette tip onto the attachment, the side wall of the pipette tip deforms inwardly between the contacts and is not widened, which keeps the force to be applied to press in the attachment low. The attachment can be pressed deeper into the pipette tip with increasing mounting force. Accordingly high ejection forces must be applied to detach the pipette tip from the attachment. Due to the contacts protruding inwards, the design is only suitable for relatively large pipette tips.

U.S. Pat. No. 6,568,288 describes a pipette tip that has axially spaced annular sealing regions and substantially cylindrical lateral support regions, wherein the sealing region is sufficiently thin as to form an interference fit and air-tight sealing between a sealing surface of the sealing zone and the sealing region when an attachment of a pipette with axially spaced lateral guide zones is introduced. The wall thickness in the sealing region is preferably between 0.2 and 0.5 mm. The sealing surface is the outer surface of an annular, radially outwardly projecting projection next to the lower end of the attachment. The pipette tip has an annular, upwardly facing and inwardly oriented shoulder on the inner circumference to limit the mounting onto the attachment. The force for mounting should be approximately two pounds (8.9 N) and for ejecting should be approximately one pound (4.45 N). Due to the depth stop, an incomplete immersion can occur when simultaneously taking up multiple pipette tips from a tray or rack by means of a multichannel pipetting device. If the tray or rack bends downward slightly between lateral edges, the two outer attachments being placed down on the shoulders of the two outer pipette tips can lead to an insufficient immersion of the other attachments into the pipette tips arranged between them.

U.S. Pat. No. 6,967,004 B2 describes a pipette tip that has an annular sealing region with an inner sealing surface on a side wall which in the sealing region is sufficiently thin as to expand slightly and form an interference fit and an air-tight seal between the sealing surface and the sealing zone of an attachment inserted into the pipette tip. The pipette tip has an annular shoulder that is oriented inwardly and upwardly and that limits the penetration of the attachment. The attachment has two cylindrical portions with different diameter. Its annular sealing zone includes a sealing edge at a connection of the lower end of a cylindrical portion and the outermost edge of a radially extending transition of the attachment. Preferably, the forces for inserting and ejecting the pipette tip are less than two pounds (8.9 N). When multiple pipette tips are taken up simultaneously by means of a multichannel pipetting device, the depth stop can lead to an insufficient immersion of attachments.

EP 2 138 234 A1 describes a pipette tip that has, on the upper end of an elongated tubular portion, a flexible tubular connecting portion for detachably connecting to a contour which is wave-like in cross-section and increases the stretchiness of the seating region. When being mounted onto the attachment, the seating region can be reversibly stretched by more than 20%. For a sealing seat, the wave-like contour must be flattened out on the attachment, making the further stretchiness only small. As a result, the pipette tip requires precise manufacturing. Furthermore, between the seating region and the tubular region, a shoulder projecting radially inward is present, which creates a depth stop for the attachment that can lead to an insufficient immersion of attachments when pipette tips are taken up by means of a multichannel pipetting device.

EP 2 606 977 A1 describes a pipette tip with the shape of an elongated tube with a lower opening on the lower end for the passage of liquid and an upper opening on the upper end, wherein, next to the upper opening on the inner circumference, a seating region is present which serves for mounting onto a standardized conical attachment of a pipetting device. The seating region has a holding region with radially inwardly protruding, axially extending ribs and, below the holding region, a sealing region with an inwardly protruding sealing projection running along the circumference. The seating region is designed so that, when being mounted on the attachment with a mounting force that ensures the pipette tip will be held and sealed on the attachment, the ribs are partially plastically deformed and an elastic deformation occurs in the seating region outside of the ribs. Below the sealing region, it has a braking region expanding conically toward the upper opening to limit the mounting. This ensures a secure seal on the attachment of a pipetting device and substantially reduces the ejection force to be applied for ejecting. The design is particularly suitable for relatively large pipette tips with a nominal volume of 2.5, 5.0, and 10 ml. For smaller pipette tips, it is less suitable due to the difficulty of producing delicate ribs.

EP 3 115 110 A1 describes a pipette tip with a tubular body and a seating region for mounting onto a conical attachment of a pipetting device, which seating region has a circumferential, inwardly protruding sealing projection on the inner circumference at a distance from the upper opening, below the sealing projection a circumferential braking region tapering downwardly more strongly than the attachment, and above the sealing projection a circumferential, inwardly protruding support projection. The sealing projection can be clamped onto the attachment in a sealing manner with elastic deformation, wherein the braking region rests against the attachment farther down and the support projection rests against the attachment farther up without pretensioning or is spaced apart from the attachment by a circumferential gap. The pipette tip can be clamped on the attachment of a pipetting device in a well-sealed and secure manner, can be ejected with reduced application of force, and is also well suited for smaller pipette tip sizes. The disadvantage is the still high application of force when clamping it onto the attachment and when scraping it off from the attachment.

WO 2011/091308 A2 describes a pipette tip that has an annular flange on the proximal end of a proximal portion and axially oriented ribs in the proximal portion that are spaced apart from each other in the circumferential direction. The flange is intended to increase the stiffness of the pipette tip and facilitate the alignment of the dispenser on the pipette tip. The ribs are intended to limit the ability of the pipette tip to be axially widened in the proximal region. The mounting forces of the pipette tips with filling volumes of 200 μl and 1000 μl on five different pipettes are over 1000 g (10 N) and reach up to 2,000 g (20 N).

An ergonomically optimized pipette tip is known from U.S. Pat. No. 7,335,337 B1, which can be securely fixed to a pipette, in which the mounting forces and ejection forces are reduced. The pipette tip has elastic expansion elements, through which the axial mounting force and ejection force are reduced. The elastic expansion elements are arranged in an upper portion of the pipette tip above a sealing ring running on the inner circumference. They are formed by outwardly curved regions of decreased wall thickness between cylindrical or cone-shaped segments of the pipette tip. When inserting an attachment of a pipette into the upper opening of the pipette tip, the expansion elements are flattened out and the segmented wall portions widen. By means of ribs on the inner side of the wall segments, the pipette tip is guided and aligned on the attachment. The mounting forces, however, are still high, because the pipette tip has a large wall thickness in the region of the circumferential sealing ring and can only bend slightly, and they increase strongly when the expansion elements are flattened out.

WO 2018/213196 A1 describes a pipette tip with a proximal portion with alternating, longitudinally oriented grooves and panels designed to facilitate widening and compression of the wall when the pipette tip is attached to and sealingly engages with an appropriately designed dispensing device. Through these measures, the axial force for clamping a pipette tip onto a dispensing device and detaching a pipette tip from a dispensing device for liquids is decreased. The grooves are stepped, V-shaped or U-shaped. A plurality of grooves and panels are alternatingly arranged on the circumference of the proximal portion. To form the grooves, constrictions and the corners at nearly right angles between grooves and panels in the molding tool must be filled during injection molding with plasticized plastic mass. This limits the application and impairs the dimensional accuracy and strength of the pipette tip. There is also a danger of the pipette tip bursting at the base of the grooves when being clamped onto the attachment and not sitting on the attachment in a sealed manner. The pronounced structuring of the proximal portion of the pipette tip also makes marking the pipette tip difficult.

### BRIEF SUMMARY OF THE INVENTION

Starting from this, the object of the invention is to provide a pipette tip that can be clamped onto an attachment of a pipetting device in a sufficiently firm and sealing manner with decreased mounting force and ejection force, that has more favorable production properties with improved dimensional accuracy and strength, and that is better suited for marking of various pipette tip types.

The pipette tip according to the invention made of plastic comprises an elongated tubular body with a lower opening at a lower end of the tubular body for the passage of liquid and an upper opening at an upper end of the tubular body for clamping onto an attachment of a pipetting device, wherein a seating region for the attachment is present next to the upper opening on the inner circumference of the tubular body, characterized in that at least one flattened area extending in the axial direction is present next to the upper opening on the outer circumference of the tubular body, the wall thickness of the tubular body gradually decreases in the flattened area towards its central region in a cross-section through the tubular body, starting from one of the two regions of the tubular body adjacent to the flattened area, and the flattened area has in the cross-section through the tubular body (i) a straight profile or (ii) a profile that is less strongly curved than the regions adjoining the flattened area.

The pipette tip according to the invention has a lower wall thickness in the region of the flattened area than at the two lateral edges of the flattened area and possibly in the regions of the tubular body adjoining the flattened area. This improves the deformability of the pipette tip when clamping onto an attachment of a pipetting device, such that a secure seal of the pipette tip on the attachment can be achieved even with comparatively lower mounting forces. The pipette tip can be designed so that it is exclusively elastically deformed when being clamped with a specific force onto a defined attachment of a pipetting device. However, it can also be designed so that it is plastically deformed when clamped with a specific force onto a defined attachment of a pipetting device. In the case of elastic deformation, the mounting force increases proportionally to the deformation. After the pipette tip is detached from the attachment, the elastic deformation can be completely reversed. When the yield point is exceeded, plastic deformation occurs. Plastic deformation is an irreversible deformation that does not reverse itself after the pipette tip is detached from the attachment. With plastic deformation, the mounting force no longer increases or only increases slightly with the deformation. Elastic or plastic deformation preferably takes place in the region of the flattened area, since the pipette tip has the lowest wall thickness next to the upper opening in the region of the flattened area. As a result, the application of force for the sealing clamping of the pipette tip onto the attachment can be kept low. In the case of plastic deformation, the mounting force can be limited to a predetermined limit value.

For production by injection molding, it is advantageous that the plastic mass can fill the cavity in the molding tool in the region of the flattened area better than in the region of the grooves in the conventional pipette tips due to the lower pressure losses at the flattened area. As a result, weld seams can also be reduced and more dimensionally accurate and stronger pipette tips can be achieved. Due to the increased strength, the pipette tips can be prevented from bursting at the locations of the lowest wall thickness due to the mounting forces.

Another advantage is that the flattened area can be used to mark the pipette tips. In particular, information about the pipette tip and/or about its production, for example, about the pipette tip size, the material or the degree of purity of the pipette tip, the manufacturer, the brand, and/or the production tool used to produce it, can be attached to the flattened area during injection molding. The pipette tip size is the largest volume that can be metered with the pipette tip. Pipette tips that differ from each other in at least one of the aforementioned criteria are also referred to in this application as “pipette tips of a different pipette tip type.” The marking can be generated during injection molding or printed on later in the form of raised or indented letters, numbers, characters, or symbols. Furthermore, marking by the user can be considered, for example, by printing, labeling by means of a writing tool, or sticking on a label. In addition, the flattened area itself can be used as a distinguishing feature to differentiate different pipette tip types from each other.

The flattened area can also serve as a roll protector to prevent a pipette tip placed on a work surface or other surface from rolling away.

In a cross-section through the tubular body, the flattened area can have a straight and/or an outwardly (convex) and/or inwardly (concave) curved profile. According to a preferred embodiment, the profile of the flattened area is largely or exclusively straight or largely or exclusively curved outward or largely or exclusively curved inward. According to one embodiment of the invention, the curvature radius along the respective profile is constant. According to another embodiment, the curvature radius varies along the respective profile or a part of it. According to another embodiment, the profile of the flattened area is straight in portions and curved identically or differently in portions. For example, the profile of the flattened area is curved outward or straight on the two edges and between them is curved outward or curved inward so that it is approximately V-shaped overall. According to another embodiment, the profile of the flattened area is curved differently in portions. The different curvature can be curvatures with different curvature radii or outward or inward curvatures with the same or different curvature radii.

If the profile of the flattened area is curved, the curvature is less than the curvature of the adjoining regions of the tubular body. The curvature refers to the reciprocal of the curvature radius of the respective profile. In an outwardly curved profile, the flattened area results from its curvature being smaller than the curvature of the adjoining regions of the tubular body. In an inwardly curved profile, the flattened area also results from the curvature being less than the curvature of the adjoining regions of the tubular body. As a result of the curvature being less than in the adjoining regions of the tubular body, the flattened area is particularly well suited for the marking of pipette tips.

According to one embodiment of the invention, the tubular body has, in a cross-section on the outer circumference at least in the regions adjoining the flattened area, a circular profile and the flattened area has a straight or a circular profile with a larger curvature radius than the regions adjoining the flattened area. According to a preferred embodiment, the regions adjoining the flattened area are circular overall. However, the invention also relates to embodiments in which the profile of the regions adjoining the flattened area deviate from a circular shape, for example, have an elliptical or otherwise curved shape. In addition, the profile of the flattened area can deviate from a straight or circularly curved shape, for example, have an elliptical or otherwise curved shape.

According to another embodiment, the tubular body has, in all cross-sections through the flattened area, a straight and/or a curved profile in the flattened area. According to a preferred embodiment, the tubular body has, in all cross-sections through the flattened area, exclusively a straight profile in the flattened area and/or, in all cross-sections through the flattened area, exclusively a curved profile in the flattened area. According to another embodiment, the tubular body has, in all cross-sections through the flattened area, exclusively a profile curved with the same curvature radius in the flattened area or, in various cross-sections, a profile curved with a different curvature radius, wherein the curvature of the profile preferably changes gradually from cross-section to cross-section. According to another embodiment, the flattened area has, in various cross-sections, an outwardly curved profile and an inwardly curved profile, wherein the curvature of the profile preferably changes gradually from cross-section to cross-section.

According to another embodiment, the flattened area has an inwardly curved profile. It is thereby, for example, an overall inwardly curved profile with the same or different curvatures or an inwardly curved profile in the central region and a straight profile on the two lateral edges, which profile is approximately V-shaped. Preferably, the inwardly curved flattened area is in a range at the circumference of more than 10°, preferably more than 30°. Preferably, at least 3 flattened areas with an inwardly curved contour are distributed uniformly over the circumference and the flattened areas with an inwardly curved contour are the same width or wider than the regions between the flattened areas with an inwardly curved contour.

According to another embodiment, the at least one flattened area extends upwards up to a distance from the upper end of the tubular body. As a result, on the upper end of the pipette tip, a circumferential upper edge with a uniform wall thickness can be achieved, which edge is advantageous for ejecting a pipette tip from the attachment by means of an ejection apparatus of the pipetting device. According to another embodiment, the upper edge of the pipette tip is a circumferential flange. The flange can be used to hold a pipette tip in a hole of a holder for pipette tips (rack).

According to another embodiment, the flattened area extends up to an upper edge of the tubular body. The extent of the flattened area up to the upper end is advantageous for the deformation of the pipette tip with reduced application of force.

According to another embodiment, the tubular body has a shoulder on the outer circumference. With the shoulder, the pipette tip can be supported in a hole of a holder for pipette tips. According to another embodiment, the flattened area extends downward at least to the shoulder or beyond.

According to another embodiment, the tubular body has multiple, preferably three, flattened areas on the outer circumference. Due to the multiple flattened areas, the application of force for the deformation of the pipette tips can be reduced further. Furthermore, different pipette tip types can be marked differently through pipette tips with a different number and/or position and/or dimensions of the flattened areas.

According to another embodiment, the flattened areas are distributed uniformly over the outer circumference of the tubular body. As a result, a uniform widening of the pipette tip can be achieved. However, the flattened areas can also be distributed non-uniformly over the outer circumference of the tubular body, in particular to mark different pipette tip types differently.

The pipette tip according to the invention comprises in particular the following embodiments:

When the pipette tip has at least one flattened area that, according to feature (i), has a straight profile in the cross-section through the tubular body, the pipette tip can have a single flattened area and a single curved adjoining region that extends from the one lateral edge of the flattened area to the other lateral edge of the flattened area. Furthermore, the pipette tip can have multiple flattened areas with a profile that is straight in the cross-section through the tubular body, which flattened areas are distributed over the circumference of the tubular body, wherein curved regions adjoin the lateral edges of the flattened areas and extend up to the lateral edges of the adjacent flattened areas. Furthermore, pipette tips are comprised that have multiple flattened areas with a profile that is straight in the cross-section through the tubular body, wherein the flattened areas adjoin each other at the lateral edges so that the flattened areas defined overall a polygon with straight sides in the cross-section through the tubular body.

When the pipette tip has at least one flattened area that, according to feature (ii), has a profile that is less strongly curved than the regions adjoining the flattened areas in the cross-section through the tubular body, the pipette tip can have a single flattened area and a single curved adjoining region that extends from the one lateral edge of the flattened area to the other lateral edge of the flattened area. Furthermore, the pipette tip can have multiple flattened areas with a profile that is curved in the cross-section through the tubular body, which flattened areas are distributed over the circumference of the tubular body, wherein curved regions adjoin the lateral edges of the flattened areas and extend up to the lateral edges of the adjacent flattened areas. The multiple flattened areas can all be curved in the same way or in different ways. In particular, they can all be curved outwardly or inwardly or outwardly and inwardly with the same or different curvatures.

According to another embodiment, the at least one flattened area runs parallel to the central axis of the tubular body or helically around the central axis of the tubular body. In the case of a helical shape, each flattened area extends, for example, only over a fraction of the circumference of the tubular body or once or more than once around the circumference of the tubular body.

According to another embodiment, the flattened areas take up a larger part of the outer circumference of the tubular body overall than the regions of the tubular body adjoining them in the circumferential direction overall. As a result, the application of force for widening the pipette tip can be decreased further.

According to another embodiment, the seating region is conical and/or cylindrical.

According to another embodiment, the tubular body has on the inner circumference of the seating region at least one sealing structure projecting inwards and running in the circumferential direction and/or at least one guide structure projecting inwards and running in the circumferential direction or having multiple portions spaced apart from each other and/or at least one braking structure projecting inwards and running in the circumferential direction or having multiple portions spaced apart from each other. According to another embodiment, the sealing structure is a sealing bead and/or the guide structure is a guide bead and/or a guide rib and/or nub- or nipple-shaped guide projections and/or the braking structure is a braking bead and/or a conical braking region.

The sealing structure creates a ring-shaped support between the attachment of the pipetting device and the pipette tip and thus a good seal with low frictional forces when mounting the pipette tip onto the attachment. Instead of an inwardly projecting sealing structure, the seating region can have a surface seal, which is formed, for example, by a conical or cylindrical or a partially conical and partially cylindrical surface.

The guide structure creates a ring-shaped support or multiple circular supports that are spaced apart from each other in the circumferential direction and/or multiple approximately punctiform supports that are spaced apart from each other in the circumferential direction between the attachment of the pipetting device and the pipette tip and thus good guidance with low frictional forces when mounting the pipette tip onto the attachment. The guide structure holds the pipette tip stably on the attachment, even if a force is introduced from the side into the lower end of the pipette tip during wall discharge (liquid discharge on a vessel wall).

The braking structure creates a ring-shaped support or a circular support or a ramp-shaped support between the attachment and the pipette tip and brakes the insertion movement of the attachment into the pipette tip. The braking effect is determined by the geometry of the braking structure and of the attachment and the material properties (in particular elasticity and roughness) of the pipette tip and the attachment.

According to another embodiment, the guide structure is arranged above the sealing structure and/or the braking structure is arranged below the sealing structure. According to another embodiment, the guide structure coincides with the sealing structure and/or the sealing structure coincides with the braking structure. For this purpose, a guide bead can be simultaneously designed as a sealing bead and/or a sealing bead can be simultaneously designed as a friction bead.

According to another embodiment, the tubular body has on the inner circumference multiple sealing structures and/or guide structures and/or friction structures that have a wave-like contour in a longitudinal section through the tubular body.

According to another embodiment, the tubular body has a widened area on the upper opening and/or an insertion bevel on the inner circumference. The widened area and/or insertion bevel facilitates the insertion of an attachment of a pipetting device into the pipette tip.

According to another embodiment, the pipette tip consists exclusively of the tubular body. According to another embodiment, the pipette tip is an air cushion pipette tip, i.e., it is designed to be used with an air cushion pipetting device. According to another embodiment, the air cushion pipette tip consists exclusively of the tubular body.

According to another embodiment, the pipette tip consists of the tubular body and of an additional component. The additional component is, for example, a small plunger that is arranged within the tubular body and can be displaced within it. It is thereby a direct displacement pipette tip, i.e., a pipette tip that can be used with a direct displacement pipetting device.

According to another embodiment, the pipette tip is produced from at least one thermoplastic, preferably from at least one polyolefin, preferably from at least one polypropylene and/or polyethylene.

According to another embodiment, the pipette tip has one or more of the following features:
the wall thickness of the tubular body in the circumferential direction next to the at least one flattened area falls in the range from 0.3 to 1 mm,
the seating region is conical on the inside with the diameter decreasing toward the bottom, wherein the cone angle of the seating region is selected from the range of 1° to 6°, preferably 1.5° to 2.5°,
the seating region is designed to be mounted onto an attachment, wherein the cone angle of the conical attachment or of the conical portion of the attachment is selected from the range of 1.0° to 10°, preferably from the range of 1.3° to 7°, further preferably from the range of 1.5° to 3°,
the sealing structure and/or guide structure and/or braking structure are distributed over the seating region in the longitudinal direction of the tubular body,
the wall thickness of the tubular body is at most 0.3 mm at the thinnest location in the region of the flattened area (outside of the sealing structure and/or guide structure and/or braking structure),
the wall thickness of the tubular body is at least 0.1 mm at the thinnest location in the region of the flattened area (outside of the sealing structure and/or guide structure and/or braking structure),
the flattened area extends in the longitudinal direction of the tubular body over a length of at least 4 mm,
the flattened area extends in the longitudinal direction of the tubular body at least across two sealing structures and/or guide structures and/or braking structures.

Furthermore, the invention relates to a pipette tip system comprising multiple pipette tips according to one of claims 1 to 16 or one of the preceding embodiments, wherein pipette tips of different pipette tip types have differently designed flattened areas and/or different markings on the flattened areas.

Furthermore, the invention relates to a pipetting system at least one pipette tip according to one of claims 1 to 16 or one of the preceding embodiments and a single-channel pipetting device with a single attachment for mounting a pipette tip and/or a multichannel pipetting device with multiple attachments for simultaneously mounting multiple pipette tips.

In the present application, the terms “vertical” and “horizontal,” “up” and “down” and terms derived therefrom such as “above” and “below” refer to an arrangement of the pipette tip with a vertically aligned central axis of the tubular body, wherein the upper opening is located at the top and the lower opening is located at the bottom.

In the present application, each cross-section through the tubular body is a plane aligned perpendicularly to the central axis of the tubular body. Each longitudinal section through the tubular body is a plane in which the central axis of the tubular body extends.

Furthermore, the central region of the flattened area refers to a line or a strip-shaped zone which runs between the two lateral edges of the flattened area, wherein the line or zone can have the same distances from the two lateral edges of the flattened area or can have different distances from the two lateral edges of the flattened area.

### BRIEF DESCRIPTION OF THE SEVERAL VIEWS OF THE DRAWINGS

The invention is explained in more detail below based on the accompanying drawing of exemplary embodiments. In the drawings:

FIG. 1 shows a pipette tip in a perspective view from the side;

FIG. 2 shows the same pipette tip in a scaled-down side view;

FIG. 3 shows the same pipette tip in a cross-section through the seating region;

FIG. 4 shows the same pipette tip in an enlarged partial section through the seating region;

FIG. 5 shows the same pipette tip in a scaled-down partial section through the seating region with an attachment of a pipetting device inserted;

FIG. 6 shows another pipette tip in a perspective view from the side;

FIG. 7 shows the same pipette tip in an enlarged side view;

FIG. 8 shows the same pipette tip in a cross-section through the seating region;

FIG. 9 shows the same pipette tip in an enlarged partial portion through the seating region;

FIG. 10 shows the same pipette tip in the enlarged partial portion through the seating region with an attachment of a pipetting device inserted.

### DETAILED DESCRIPTION OF THE INVENTION

In the following explanation of various exemplary embodiments, the structures and components referred to with the same designations are provided with the same reference signs.

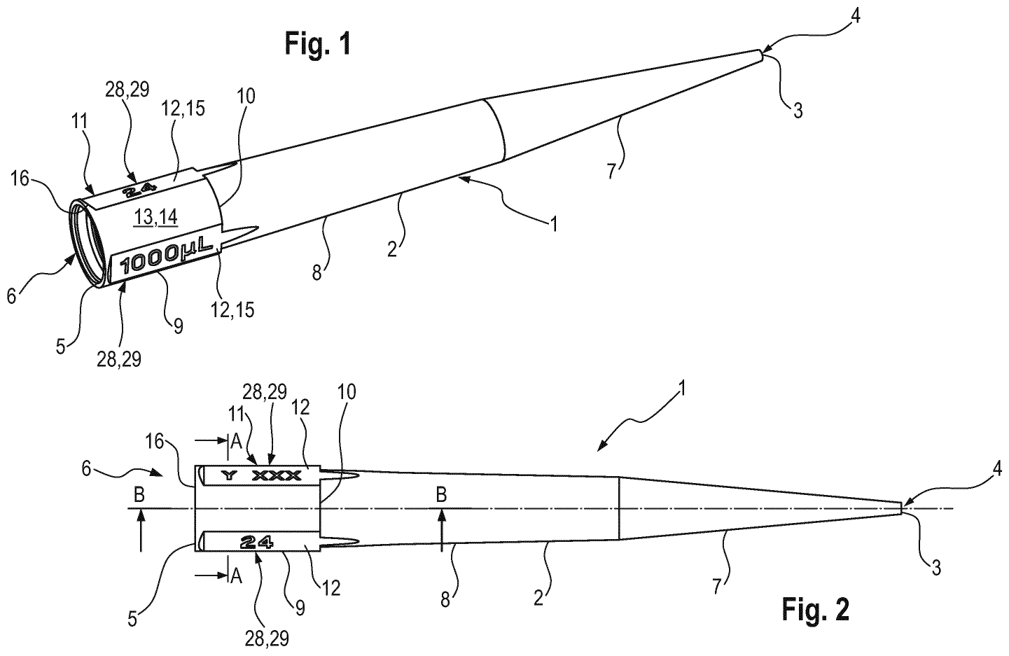

According to FIGS. 1 to 4, a pipette tip 1 has an elongated tubular body 2 which has a lower opening 4 on the lower end 3 and an upper opening 6 on the upper end 5. The lower opening 4 is smaller than the upper opening 6.

Generally, the inner and the outer diameters of the tubular body 2 increase from the lower opening 4 toward the upper opening 6. The tubular body 2 has at the bottom a conical beginning portion 7, above it a middle portion 8 with a smaller cone angle than the beginning portion 7, and above that a cylindrical head portion 9 with larger dimensions than the middle portion 8. Adjoining the middle portion 8, an outer shoulder 10 oriented downward runs on the underside of the head portion 9 on the outer circumference of the tubular body 2.

On the outer circumference 11 of the head portion, flattened areas 12 extending in the axial direction are present. In the example, there are three flattened areas 12. The flattened areas 12 begin at a small distance from the upper end 5 of the tubular body 2 and extend downward past the head portion 9 until approximately past the shoulder 10 into the upper region of the middle portion 8. The flattened areas 12 are aligned parallel to the central axis of the tubular body 2. The flattened areas 12 are arranged uniformly distributed around the outer circumference 11 of the tubular body. In the example, the flattened areas 12 are each approximately the same width as the adjoining regions 13.

The tubular body 2 has, in each cross-section through the flattened areas 12 on the outer circumference 11, a circular curved profile 14 in the regions 13 adjoining the flattened areas 12 and a straight profile 15 in the flattened areas 12. The circular profiles 14 extend across the entire distance range between two adjacent flattened areas 12, i.e., the profiles 14 are circular everywhere between the flattened areas 12. This is shown in particular in FIG. 3.

Above the flattened areas 12, the tubular body 2 has a circumferential edge 16 with a uniform wall thickness.

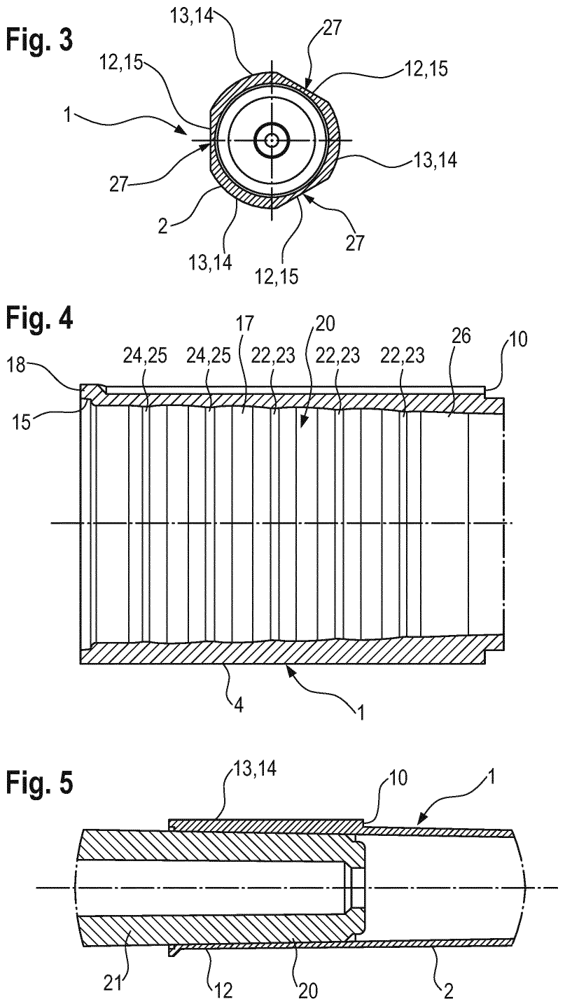

On the upper end, the tubular body 2 has on the inner circumference 17 a widened area 18 with an insertion bevel 19. This is shown in particular in FIG. 4.

Next to the upper opening 6, the tubular body 2 has on the inner circumference 17 a substantially conical or cylindrical seating region 20 for a conical or cylindrical attachment 21 of a pipetting device. The seating region 20 extends into the head portion 9 and is conical with a cone angle of, for example, 2° to 6°.

The tubular body 2 has on the inner circumference 17 in the seating region 20 multiple sealing structures 22 in the form of inwardly projecting sealing beads 23 running in a circumferentially closed manner which are spaced apart from each other in the axial direction. Furthermore, the tubular body 2 has, at a small distance from the upper opening 6, inwardly projecting guide structures 24 running in a circumferentially closed manner in the form of guide beads 25 which are spaced apart from each other. Overall, the tubular body 2 has in the seating region 20 sealing and guide structures 22, 24 that are wave-like in longitudinal section.

Below the sealing structures 22, a conical braking region 26 is present on the inner circumference of the head portion 9.

On the lower end of the head portion 9, the inner contour of the tubular body 2 transitions smoothly into the downwardly tapering middle portion 8, which transitions into the beginning portion 7 farther down.

According to FIG. 3, the tubular body 2 has in the cross-section a constant wall thickness overall in the adjoining regions 13 between the flattened areas 12. Furthermore, the wall thickness of the tubular body 2 decreases in the flattened areas 12, in each case starting from the adjoining regions 13, toward the central region 27 of the flattened areas 12.

According to FIGS. 1 and 2, the flattened areas 12 are provided with markings 28. These are thereby labels 29 in the form of raised or indented numbers and letters, which are generated during injection molding of the pipette tip 1. The labels 29 indicate the pipette tip size and the nest of the injection molding tool in which the pipette tip 1 is injection molded.

For clamping onto the attachment 21 of a pipetting device, one or more pipette tips 1 can be kept ready in holes of a holder for pipette tips, wherein they are supported with the shoulder 10 on the edge of the holes. According to FIG. 5, the attachment 21 of a pipetting device can be easily inserted into the pipette tip 1 through the widened area 18 with the insertion bevel 19 on the upper opening 6. It is guided therein in a low-friction manner by the guide structures 24 and the sealing structures 22. When clamping onto the attachment 21, the pipette tip 1 can be elastically and/or plastically deformed in the region of the flattened areas 12, as a result of which the mounting forces are decreased and a secure seal of the attachment 21 on the sealing structures 22 is achieved with relatively lower mounting forces.

After the pipetting of liquid, the pipette tip 1 can be easily ejected from the attachment 21, since the ejection forces to be applied for ejection are also reduced. For the ejecting, an ejection sleeve of the pipetting device guided on the attachment 21 is pressed against the circumferential edge 16 on the upper end 5 of the pipette tip 1 and the pipette tip is stripped off the attachment 21.

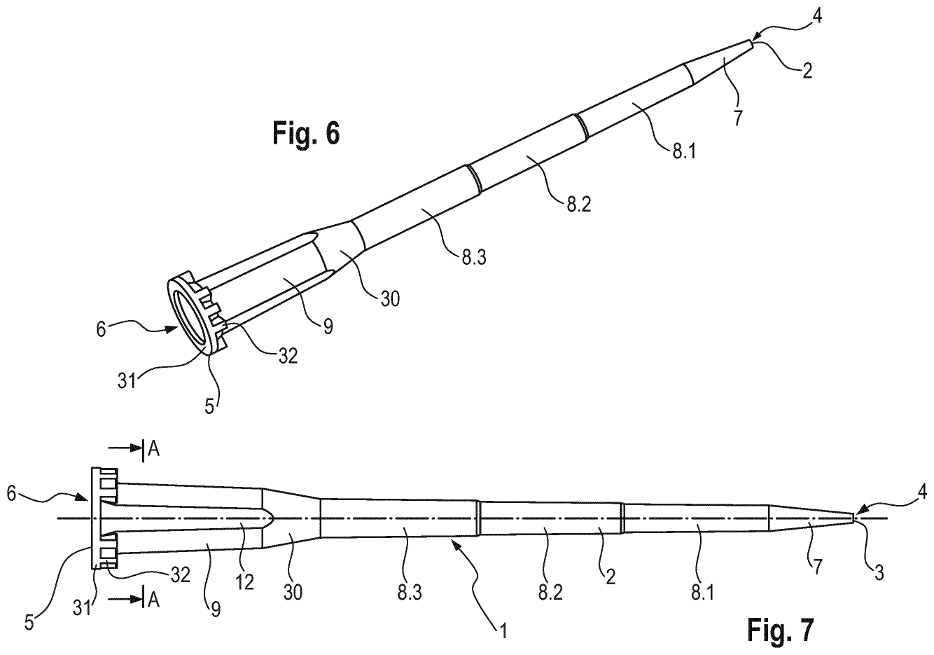

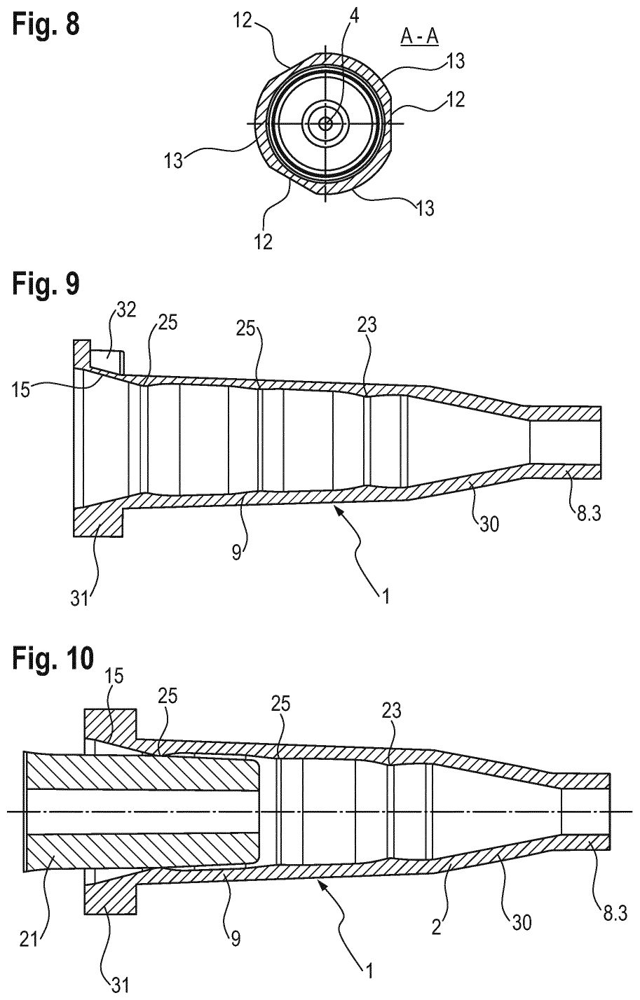

The pipette tip 1 from FIGS. 6 to 10 is preferably designed for pipetting smaller filling volumes than the pipette tip 1 from FIGS. 1 to 5. The pipette tip 1 differs from the one described above in particular in that the elongated tubular body 2 has, above the conical beginning portion 7, multiple conical middle portions 8.1, 8.2, 8.3, above that a conical transition portion 30 and above that a conical head portion 9 with a circumferential, radially outwardly projecting flange 31 on the upper end 5. The previously designated portions 7, 8.1, 8.2, 8.3, 40 and the flange 31 connect directly to each other. The outer diameter of the tubular body 2 enlarges gradually from the lower end 3 to the upper end of the head portion 9. The inner diameter of the tubular body 2 also in principle enlarges gradually from the lower end 3 to the upper end 5 of the tubular body 2.

This pipette tip 1 has no shoulder between the middle portion and the head portion.

The flange 31 has on the underside downwardly projecting ribs 32 that extend radially outward starting from the head portion 9.

The flattened areas 12 extend starting from the underside of the flange 31 in the axial direction of the tubular body 2 until the upper edge region of the transition portion 30. This pipette tip 1 also has three planar flattened areas 12. The adjoining regions 13 of the head portion 9 each have in the cross-section a circular profile that extends over the entire region between two adjacent flattened areas 12.

One or more pipette tips 1 according to FIGS. 6 to 10 can be provided in a holder for pipette tips. In this case, they are inserted into holes of the holder and supported with the ribs 32 on the underside of the flange 31 on the edge of the holes. According to FIG. 10, the attachment 21 is only partially shoved into the pipette tip 1 up to the uppermost guide bead 25. Farther down, the pipette tip 1 has another guide bead 25 and below it has a sealing bead 23. The attachment is shoved forward to the sealing bead 23 so that the pipette tip 1 is aligned and clamped in a sealing manner onto the attachment 21. The guide beads 25 also contribute to sealing the pipette tip 1 on the attachment 21.

The sealing bead 23 is simultaneously a braking bead, which brakes the insertion of an attachment into the pipette tip 1. The braking effect is determined by the bevel at the upper edge and the rounding on the crest of the sealing bead 23.

### LIST OF REFERENCE SIGNS

1 Pipette tip
2 Tubular body
3 Lower end
4 Lower opening
5 Upper end
6 Upper opening
7 Beginning portion
8 Middle portion
9 Head portion
10 Shoulder
11 Outer circumference
12 Flattened area
13 Adjoining region
14 Curved profile
15 Straight profile
16 Edge
17 Inner circumference
18 Widened area
19 Insertion bevel
20 Seating region
21 Attachment
22 Sealing structure
23 Sealing bead
24 Guide structure
25 Guide bead
26 Conical braking region
27 Central region
28 Marking
29 Label
30 Transition portion
31 Flange
32 Rib

1. A pipette tip made of plastic with an elongated tubular body (2) with a lower opening (4) at the lower end (3) for the passage of liquid and an upper opening (6) at the upper end (5) for clamping onto an attachment (21) of a pipetting device, wherein a seating region (20) for the attachment (21) is present next to the upper opening (6) on the inner circumference of the tubular body (2), characterized in that at least one flattened area (12) extending in the axial direction is present next to the upper opening (6) on the outer circumference (11) of the tubular body (2), the wall thickness of the tubular body (2) gradually decreases in the flattened area (12) towards its central region (27) in a cross-section through the tubular body (2), starting from one of the two regions (13) of the tubular body (2) adjacent to the flattened area (12), and the flattened area (12) has in the cross-section through the tubular body (2) (i) a straight profile or (ii) a profile (15) that is less strongly curved than the adjoining regions (13).

2. The pipette tip according to claim 1, in which the tubular body (2) has, in a cross-section on the outer circumference (11) in the regions (13) adjoining the flattened area (12), a circularly curved profile (14) and has in the flattened area a straight profile (15) or a circular profile with a larger curvature radius than in the regions (13) adjoining the flattened area (12).

3. The pipette tip according to claim 1, in which the tubular body (2) has in the flattened area (12) a straight and/or a curved profile (15) in all cross-sections through the at least one flattened area (12).

4. The pipette tip according to claim 1, in which the at least one flattened area (12) extends in the axial direction at least over a part of the seating region (20).

5. The pipette tip according to claim 1, in which the at least one flattened area (12) extends upwards up to a distance from the upper end (5) of the tubular body (2).

6. The pipette tip according to claim 1, in which the at least one flattened area (12) extends up to the upper end (5) of the tubular body (2).

7. The pipette tip according to claim 1, in which the at least one flattened area (12) extends downwards to a shoulder (10) on the outer circumference (11) of the tubular body (2) or beyond it.

8. The pipette tip according to claim 1, in which the tubular body (2) has multiple, preferably three, flattened areas (12) on the circumference.

9. The pipette tip according to claim 1, in which the flattened areas (12) are distributed uniformly over the outer circumference (11) of the tubular body (2).

10. The pipette tip according to claim 8, in which the flattened areas (12) take up a larger part of the outer circumference (11) of the tubular body (2) overall than the regions (13) of the tubular body (2) adjoining them in the circumferential direction overall.

11. The pipette tip according to claim 1, in which, in the cross-section through the tubular body (2), multiple flattened areas with a straight profile define an outer circumference (11) of the tubular body (2) in the form of a polygon, preferably of a regular polygon.

12. The pipette tip according to claim 1, in which the tubular body (2) has on the inner circumference (17) of the seating region (20) at least one sealing structure (22) projecting inwards and running in the circumferential direction and/or at least one guide structure (24) projecting inwards and running in the circumferential direction or having multiple portions spaced apart from each other and/or at least one braking structure (26) projecting inwards and running in the circumferential direction or having multiple portions spaced apart from each other.

13. The pipette tip according to claim 12, in which the tubular body (2) has on the inner circumference (17) multiple sealing structures (22) and/or guide structures (24) and/or braking structures (30) that have a wave-like contour in a longitudinal section through the tubular body (2).

14. The pipette tip according to claim 1, in which the tubular body (2) has a widened area (18) and/or an insertion bevel (19) on the upper opening (6).

15. The pipette tip according to claim 1, which is produced from at least one thermoplastic, preferably from at least one polyolefin, preferably from at least one polypropylene and/or ethylene.

16. The pipette tip according to claim 1 with one or more of the following features:
the wall thickness of the tubular body in the circumferential direction next to the at least one flattened area falls in the range from 0.3 to 1 mm,
the seating region is conical on the inside with the diameter decreasing toward the bottom, wherein the cone angle of the seating region is selected from the range of 1° to 6°, preferably 1.5° to 2.5°,
the seating region is designed to be mounted onto an attachment, wherein the cone angle of the conical attachment or of the conical portion of the attachment is selected from the range of 1.0° to 10°, preferably from the range of 1.3° to 7°, further preferably from the range of 1.5° to 3°,
the sealing structure and/or guide structure and/or braking structure are distributed over the seating region in the longitudinal direction of the tubular body,
the wall thickness of the tubular body is at most 0.3 mm at the thinnest location in the region of the flattened area (outside of the sealing structure and/or guide structure and/or braking structure),
the wall thickness of the tubular body is at a minimum 0.1 mm at the thinnest location in the region of the flattened area (outside of the sealing structure and/or guide structure and/or braking structure),
the flattened area extends in the longitudinal direction of the tubular body over a length of at least 4 mm,
the flattened area extends in the longitudinal direction of the tubular body at least across two sealing structures and/or guide structures and/or braking structures.

17. A pipette tip system comprising multiple pipette tips (1) according to claim 1, wherein pipette tips of different pipette tip types have differently designed flattened areas (12) and/or different markings on the flattened areas (12).

18. A pipetting system comprising at least one pipette tip according to claim 1 and a single-channel pipetting device with a single attachment (21) for mounting a pipette tip (1) and/or a multichannel pipetting device with multiple attachments (21) for simultaneously mounting multiple pipette tips (1).
